(19) United States
(12) Patent Application Publication
(10) Pub. No.: US 2017/0169852 A1
(43) Pub. Date: Jun. 15, 2017

(54) METHOD FOR RESUMING PLAYING AUDIO-VIDEO FILE AFTER MUTING AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Ruotao Wang, Beijing (CN)

(21) Appl. No.: 15/240,378

(22) Filed: Aug. 18, 2016

Related U.S. Application Data
(63) Continuation of application No. PCT/CN2016/088852, filed on Jul. 6, 2016.

(30) Foreign Application Priority Data
Dec. 14, 2015 (CN) 201510924936.8

(51) Int. Cl. G11B 27/00; H04N 21/45; H04N 21/472; G11B 27/10; H04N 21/439

(52) U.S. Cl. CPC G11B 27/005; G11B 27/10; H04N 21/4396; H04N 21/47217; H04N 21/4524

(57) ABSTRACT

A method and terminal device for resuming playing an audio-video file after muting is disclosed in the disclosure, which includes: acquiring a first playing position at switching time, if a switch to a mute mode is detected, during a playing process of an audio-video file; prompting whether to resume playing from the first playing position, if a switch from the mute mode to a non-mute mode is detected; and resuming playing the file from the first playing position, if it is selected to resume playing from the first playing position.

### CROSS-REFERENCE TO RELATED APPLICATIONS

This application is a continuation of international application No. PCT/CN2016/088852 filed on Jul. 6, 2016 (attached hereto as an Appendix), and claims the priority of the Chinese patent application No. 201510924936.8 and filed on Dec. 14, 2015, the contents of all of which are incorporated herein by reference in entirety.

### BACKGROUND

Field

The present disclosure refers to a technical field of multi-media playing, and specifically, to a method for resuming playing an audio-video file after muting and an electronic device.

Description of Related Information

Playing multi-media, such as music, video, or etc., is a way usually used by people to relax themselves. Various softwares for playing multi-media emerge one after another, and there also exist various devices for multi-media playing, including recorder, monoplayer, MP3, MP4, computer and the like. Nowadays, smart-phones, in which functions such as multi-media playing, communication and photographing are integrated, are most commonly used terminal devices.

A terminal device has a loudspeaker. However, one will usually set the loudspeaker to be in a mute mode temporarily so as to avoid disturbing others, when he/she plays an audio or video by opening a multi-media playing software in relatively quiet scenes, such as library, classroom, office, cafe, cinema, meeting room, or the like. Frames continue to be played after the loudspeaker is set to the mute mode. After such a sudden event ends, the user needs to work manually to get to a playing position before the mute mode is set, which is somewhat troublesome.

In the prior art, after the mute mode is set, the user needs to adjust a playing position by dragging a progress bar to resume playing a video from the position before the mute mode is set. However, it is difficult to accurately return to the position, due to the size of the touch screen and the limit of accuracy in adjusting, which brings great inconvenience to the user, resulting in bad user experience.

### Overview

In view of the above, the present disclosure is directed to provide a method for resuming playing an audio-video file after muting and an electronic device, thereby solving the problem that after an audio-video file is set to be in a mute mode, the user cannot timely find out an original playing position before the mute mode is set.

According to a first aspect of embodiments of the present disclosure, there provides a method for resuming playing an audio-video file after muting, which includes:

acquiring a first playing position at switching time, if a switch to a mute mode is detected, during a playing process of an audio-video file;

prompting whether to resume playing from the first playing position, if a switch from the mute mode to a non-mute mode is detected; and

resuming playing the audio-video file from the first playing position, if the audio-video file is selected to resume playing from the first playing position.

According to a second aspect of embodiments of the present disclosure, there provides a non-volatile computer storage medium which is stored with computer executable instructions, and the computer executable instructions are configured for performing any one of the above methods for resuming playing a muted audio-video file.

According to a third aspect of embodiments of the present disclosure, there provides an electronic device including one or more processors and a memory, wherein, the memory is stored with instructions executable by the one or more processors, and the instructions are set to perform any one of the above methods for resuming playing a muted audio-video file.

### BRIEF DESCRIPTION OF THE DRAWINGS

In order to more clearly illustrate the technical solutions of the embodiments of the present disclosure or of the prior art, the drawings needed in the description of the embodiments or the prior art will be briefly introduced below. Apparently, the drawings in the description below are only some embodiments of the present disclosure, and other drawings may also be obtained by one of ordinary skills in the art according to these drawings without creative work.

FIG. 1 is a schematic flowchart of a method for resuming playing an audio-video file after muting according to an embodiment of the disclosure;

FIG. 2 is a schematic flowchart of a method for resuming playing an audio-video file after muting according to another embodiment of the disclosure;

FIG. 3 is a schematic structure diagram of a terminal device for resuming playing an audio-video file after muting according to an embodiment of the disclosure;

FIG. 4 is a schematic structure diagram of a terminal device for resuming playing an audio-video file after muting according to another embodiment of the disclosure;

FIG. 5 is a schematic structure diagram of hardware of an electronic device for resuming playing a muted audio-video file according to an embodiment of the disclosure.

### DETAILED DESCRIPTION

Exemplary embodiments will be explained in detail herein, examples of which are illustrated in the attached drawings. In the explanations in connection with the attached drawings, the same number in various drawings denotes the same or like element, unless indicated otherwise. The exemplary embodiments described below do not represent all the embodiments in consistency with the present disclosure. Rather, they are just examples of the device and method that are consistent with some aspects of the present disclosure as described in detail in the attached claims.

Hereinafter, the present disclosure is further explained in detail by referring to the attached drawings in connection with specific embodiments, such that the purposes, technical solutions and advantages of the present disclosure will become more obvious.

In order to overcome the existing problems in prior art, the present disclosure provides a method for conveniently returning to a position before a mute mode is set, in which after an audio-video file is set to the mute mode, a current playing position is recorded and the audio-video file continues to be played, and if the user triggers a preset button on the screen to resume playing from the position before the mute mode is set, the recorded playing position is called and the audio-video file returns to the position before the mute mode is set and continues to be played.

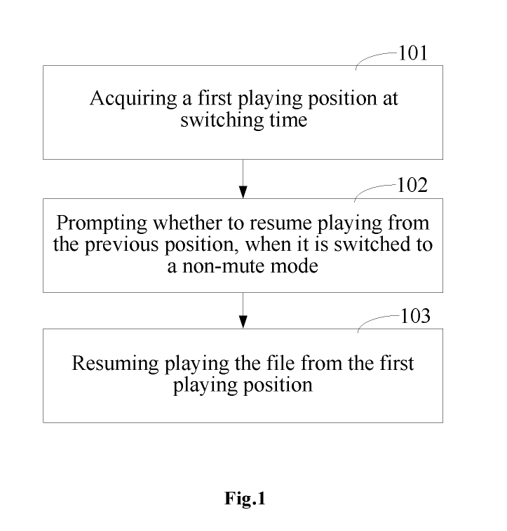

Referring to FIG. 1, an embodiment of the method for resuming playing an audio-video file after muting of the present disclosure includes the following steps.

In step 101, a first playing position at switching time is acquired, if a switch to a mute mode is detected, during a playing process of an audio-video file.

In step 102, whether to resume playing from the first playing position is prompted, if a switch from the mute mode to a non-mute mode is detected.

In step 103, playing the audio-video file from the first playing position is resumed, if the audio-video file is selected to resume playing from the first playing position.

Wherein, the file discussed above may be a video file or audio file.

In step 101, the first playing position may be information on time, position of a progress bar, frame number, or the like. The acquired first playing position may be stored in temporary storage media such as RAM and the like, and may also be stored in non-temporary storage media such as hard disk and the like.

The first playing positions at the switching time acquired in the above steps may be one or more, for example, playing positions at switching time of each switch to the mute mode, may be respectively stored; A list of the stored playing positions at the switching time is displayed and it is prompted to select the position for resuming playing, if the switch from the mute mode to the non-mute mode is detected. The user may switch a plurality of times between the mute mode and the non-mute mode due to scenes where quietness are required occur multiple of times at intervals, just due to hurry or the like, thus the playing position corresponding to each switch may be respectively or sequentially stored. Therefore, when the user hopes to enjoy a show, a position to resume playing is prompted after switching to the non-cute mode, thereby the user may select a position at the foremost or other switching time, to resume playing the current audio-video file.

Of course, in the above processes, it may be set as default to prompt the user to select a position at the nearest switching time to resume playing. The user may also input instructions to call positions at other stored switching time to resume playing when necessary.

As an alternative embodiment, for video file, the step of acquiring the first playing position may further include acquiring a current frame of the first playing position and generating a thumbnail of the current frame which may be stored together with the first playing position; the step of prompting whether to resume playing from the position before switching to the mute mode further includes simultaneously displaying the thumbnail of a current frame of the first playing position.

Or, the step of acquiring and storing the first playing position may further include acquiring a current frame of the first playing position or a video clip near the first playing position and generating a thumbnail of the current frame or a thumbnail video of the video clip; the step of prompting whether to resume playing from the first playing position further includes simultaneously displaying the thumbnail of the current frame of the first playing position or the thumbnail video of the video clip.

As a result, the user is provided with more prompts, such that the user is able to know a position to be selected.

If the file is played online, the step of acquiring and storing the first playing position further includes acquiring a playing position at switching time of each switch to the mute mode; if a switch from the mute mode to the non-mute mode is detected, a list of the acquired playing position at the switching time of each switch to the mute mode, is displayed, and it is prompted to select the position for resuming playing.

In addition, the method beforehand may further include:

detecting state of sound playing of the terminal device and a scene in which the terminal device is located, when a instruction for playing the file is received from the user;

switching to the mute mode to play the file according to a instruction received for switching to the mute mode, if the terminal device is in a loudspeaker turn-on mode and in a scene where quietness is required.

Thus, whether the file is played in the mute mode is controlled by determining whether the terminal device is in the scene where quietness is required, such that when the terminal device is in the scene where quietness is required, the mute mode may be automatically activated to prevent the terminal device from suddenly making a sound in the scene where quietness is required, so as to avoid disturbing others or being impolite.

Alternatively, the step of detecting the state of the sound playing of the terminal device and the scene in which the terminal device is located includes:

detecting the state of the sound playing of the terminal device, and determining whether the terminal device is in the loudspeaker turn-on mode;

detecting location information of the terminal device and determining whether the terminal device is in the scene where quietness is required, if the terminal device is in the loudspeaker turn-on mode.

Alternatively, the step of determining whether the terminal device is in the scene where quietness is required includes:

determining whether a location of the terminal device is currently in the scene where quietness is required by positioning a coordinate of the location of the terminal device through GPS and matching a current location in an electronic map database based on the coordinate of the location; and/or

determining whether a current IP address is the scene where quietness is required by matching the current IP address with pre-stored IP addresses in a quiet-scene database.

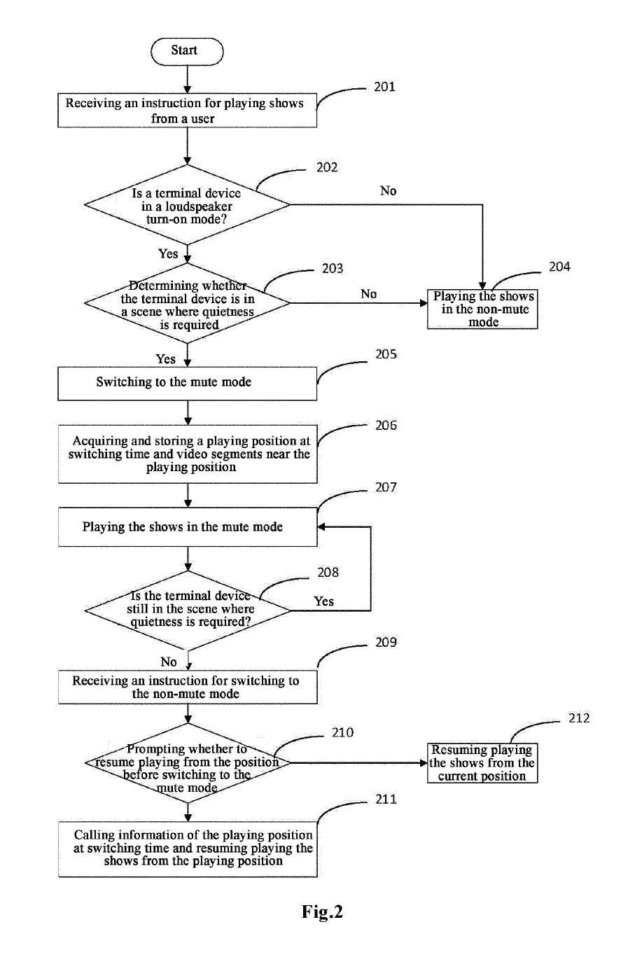

The method for resuming playing an audio-video file after muting provided by the present disclosure is further described below through an alternative embodiment. As illustrated in FIG. 2, the present embodiment includes mainly the following steps.

In step 201, an instruction for playing a file is received from the user.

In step 202, it is determined whether the terminal device is in a loudspeaker turn-on mode; if not, then step 204 is performed, which means that a headphone is inserted in a headphone jack of the terminal device such that the terminal device may not affect others even if the terminal device plays the file; and if yes, then step 203 is performed.

In step 203, it is determined whether the terminal device is in the scene where quietness is required; if not, then step 204 is performed, and if yes, then step 205 is performed. In the step, whether a location of the terminal device is in the scene where quietness is required may be determined by positioning the location of the terminal device through GPS; the IP address through which the terminal device currently connects to the network may be acquired and whether a IP address is the scene where quietness is required may be determined by matching the IP address with a pre-stored IP address in the quiet-scene database, such that whether the terminal device is in the scene where quietness is required may be determined conveniently and rapidly.

In step 204, the file is played in a non-mute mode.

In step 205, the terminal device is switched to a mute mode.

Wherein, an additional step may be inserted between the steps 204 and 205: prompting whether to play the file in the mute mode, while stopping playing the file; if the mute mode is selected by the user, then the step 205 is performed, and if not, then the step 204 is performed.

In step 206, a first playing position at switching time and a video clip near the first playing position is acquired, and the first playing position is stored together with a thumbnail video of the video clip generated by compressing the video clip.

Wherein, the video clip near the first playing position, which is a video clip within a threshold period of time which is preset based on the first playing position, for example, a period of time of 2 seconds after (or before or before and after) the first playing position used as a starting point (or an end point or a central point), are acquired.

If the audio-video file is played online, the step may further include acquiring and storing video file data within a predetermined period of time from the first playing position. The threshold period of time may be properly selected according to local storage capacity and network download speed, for example, if the local storage capacity is sufficient high, the threshold period of time may be set to be relatively long to buffer more video file data.

In step 207, the file is played in the mute mode.

Wherein, the present step may be performed in synchronization with the steps 205 and 206.

In step 208, it is determined timely whether the terminal device is in the scene where quietness is required; if yes, then returning to step 207, and if not, then step 209 is performed. Alternatively, the file is played in a volume before switching to the mute mode.

In step 209, if an instruction for switching from the mute mode to the non-mute mode is detected or received, step 210 is performed.

In step 210, a thumbnail video of the video clip near the time before switching to the mute mode is played, while prompting whether to resume playing from a position before switching to the mute mode; if “Yes” is selected by the user, then step 211 is performed; otherwise, step 212 is performed.

In step 211, the first playing position stored is called and playing the file from the first playing position is resumed.

If the file is played online, then the video file data stored is called firstly and played, and subsequent video file data is downloaded during playing. As a result, relevant video file data can be called timely and replayed, and video file data after local video file data may be also downloaded timely from the network during the playing of the local video file data, such that continuity of playing is ensured so as to improve the user experience.

In step 212, playing the file from the current position is resumed.

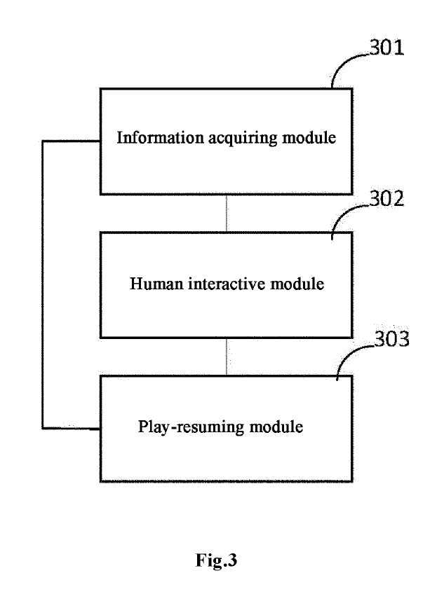

Referring to FIG. 3, another embodiment of the disclosure further provides a terminal device for resuming playing an audio-video file after muting, the device includes:

an information acquiring module 301, configured for acquiring and storing a first playing position when a switch to a mute mode is detected, during a playing process of an audio-video file;

a human interactive module 302, configured for prompting whether to resume playing from the first playing position when a switch from the mute mode to a non-mute mode is detected, and informing a play-resuming module when an instruction for resuming playing from the first playing position is received from a user; and

a play-resuming module 303, configured for calling information of the first playing position from the information acquiring module and resuming playing the file from the first playing position.

Wherein, the information acquiring module 301 may be further configured for acquiring a current frame of the first playing position or a video clip near the first playing position, and generating a thumbnail of the current frame or a thumbnail video of the video clip.

The human interactive module 302 is further configured for displaying the thumbnail of the current frame of the first playing position or the thumbnail video of the video clip, while prompting whether to resume playing from the first playing position.

Alternatively, the information acquiring module 301 is further configured for acquiring and storing video file data within a predetermined period of time from the first playing position, when the file is played online;

The play-resuming module 303 is further configured for calling and playing the video file data, and downloading subsequent video file data during the playing.

The information acquiring module 301 may be further configured for acquiring a playing position at switching time of each switch to the mute mode.

The human interactive module 302 is further configured for displaying a list of the acquired playing position at the switching time of each switch to the mute mode, and prompting to select the position for resuming playing, if the switch from the mute mode to the non-mute mode is detected.

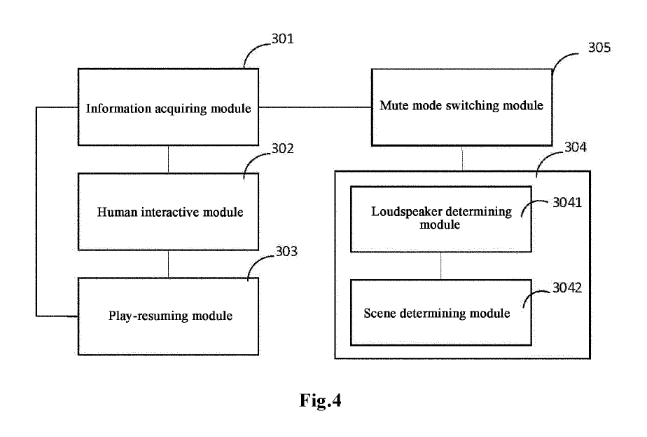

In addition, referring to FIG. 4, the terminal device according to an embodiment further includes:

a determining module 304, configured for detecting state of sound playing of the terminal device and a scene in which the terminal device is located, when an instruction for playing a file is received from a user; and

a mute mode switching module 305, configured for switching to a mute mode to play the file according to a received instruction for switching to the mute mode, when the terminal device is in a loudspeaker turn-on mode and in a scene where quietness is required.

Wherein, the determining module 304 further includes: a loudspeaker determining module 3041, configured for detecting the state of the sound playing of the terminal device and determining whether the terminal device is in the loudspeaker turn-on mode;

a scene determining module 3042, configured for detecting location information of the terminal device and determining whether the terminal device is in the scene where quietness is required.

Alternatively, the scene determining module 3042 determines whether a location of the terminal device is currently in the scene where quietness is required by positioning a coordinate of the location of the terminal device through GPS and matching a current location in an electronic map database based on the coordinate of the location; and/or the scene determining module 3042 determines whether a current IP address is the scene where quietness is required by matching the IP address with a pre-stored IP address in a quiet-scene database.

The embodiments of the present disclosure further provide a non-volatile computer storage medium, wherein the non-volatile computer storage medium is stored with computer executable instructions which are used to perform any of the methods for resuming playing a muted audio-video file in the above embodiments.

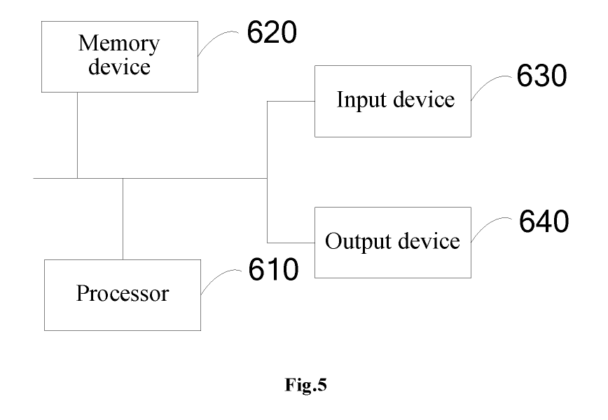

FIG. 5 is a schematic structure diagram of hardware of an electronic device for resuming playing a muted audio-video file according to an embodiment. As shown in FIG. 5, the device includes one or more processors 610 and a memory 620, and FIG. 5 illustrates one processor 610 as an example.

The electronic device for resuming playing a muted audio-video file may further include an input device 630 and an output device 640.

The processor 610, memory 620, input device 630 and output device 640 may be connected with each other through bus or other ways. FIG. 5 illustrates bus connection as an example.

As a non-volatile computer readable storage medium, the memory device 620 may be configured to store non-volatile software program, non-volatile computer executable program and modules, such as program instructions/modules corresponding to the method for resuming playing a muted audio-video file according to the embodiments of the disclosure (for example, information acquiring module 301, human interactive module 302 and play-resuming module 302, as illustrated in FIG. 3). By executing the non-volatile software program, instructions and modules stored in the memory 620, the processor 610 may perform various functional applications of the server and data processing, that is, the method for resuming playing a muted audio-video file according to the above mentioned embodiments.

The memory device 620 may include a program storage area and a data storage area, wherein the program storage area may be stored with the operating system and applications which are needed by at least one functions, and the data storage area may be stored with data which is created according to use of the device for resuming playing a muted audio-video file, and the like. Further, the memory 620 may include a high-speed random access memory, and may further include a non-volatile memory, such as at least one of disk memory device, flash memory device or other types of non-volatile solid state memory device. In some embodiments, optionally, the memory 620 may include a memory provided remotely with respect to the processor 610, and such memory may be connected with the device for resuming playing a muted audio-video file through network. The examples of the network may include but not limited to Internet, intranet, LAN (Local Area Network), mobile communication network or combinations thereof.

The input device 630 may receive inputted digital or character information, and generate key signal input related to the user settings and functional control of the device for resuming playing a muted audio-video file. The output device 640 may include a display device such as a display screen and the like.

The above one or more modules may be stored in the memory 620, when these modules are executed by the one or more processor 610, the method for resuming playing a muted audio-video file according to any one of the above embodiments may be performed.

The above product may perform the methods provided in the embodiments of the disclosure, and include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID, UMPC devices and the like, such as iPad;

(3) portable entertainment device, which can display and play multimedia contents, and includes audio or video player (such as iPod), portable game console, e-book and smart toys and portable vehicle navigation device;

(4) server, which is an device for providing computing service, and constituted by processor, hard disc, memory, system bus and the like, wherein the server has a framework similar to that of a computer, but is demanded for superior processing ability, stability, reliability, security, extendibility and manageability due to high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for resuming playing an audio-video file after muting, comprising:
at an electronic device:
acquiring a first playing position at switching time, during a playing process of the audio-video file, if a switch to a mute mode is detected;
prompting whether to resume playing from the first playing position, if a switch from the mute mode to a non-mute mode is detected; and
resuming playing the audio-video file from the first playing position, if the audio-video file is selected to resume playing from the first playing position.

2. The method according to claim 1 or the invention of any claim herein, wherein the audio-video file is a video file, and
the acquiring the first playing position further comprises: acquiring a current frame of the first playing position or a video clip near the first playing position, and generating a thumbnail of the current frame or a thumbnail video of the video clip; and
the prompting whether to resume playing from the first position further comprises: simultaneously displaying the thumbnail of the current frame of the first playing position or the thumbnail video of the video clip.

3. The method according to claim 1 or the invention of any claim herein, wherein the audio-video file is played online, and
the acquiring the first playing position at the switching time further comprises: acquiring audio-video file data within a predetermined period of time from the first playing position; and
calling firstly the audio-video file data and playing the audio-video file data if the audio-video file is selected to resume playing from the first playing position, and downloading subsequent audio-video file data during the playing.

4. The method according to claim 1 or the invention of any claim herein, wherein the acquiring the first playing position at the switching time comprises: acquiring each playing position at switching time of switching to the mute mode; and
if the switch from the mute mode to the non-mute mode is detected, the method further comprises: displaying a list of each playing position at the switching time of switching to the mute mode acquired, and prompting to select the position for resuming playing.

5. The method according to claim 1 or the invention of any claim herein, wherein before the acquiring a first playing position at switching time, the method further comprises:
detecting a state of sound playing of a terminal device and a scene in which the terminal device is located, when an instruction for playing the audio-video file is received from a user; and
switching to the mute mode to play the audio-video file according to a received instruction for switching to the mute mode, if the terminal device is in a loudspeaker turn-on mode and in a scene where quietness is required.

6. The method according to claim 5 or the invention of any claim herein, wherein the detecting the state of the sound playing and the scene in which the terminal device is located comprises:
detecting the state of the sound playing of the terminal device and determining whether the terminal device is in the loudspeaker turn-on mode; and
detecting location information of the terminal device and determining whether the terminal device is in the scene where quietness is required, if the terminal device is in the loudspeaker turn-on mode.

7. The method according to claim 6 or the invention of any claim herein, wherein the determining whether the terminal device is in the scene where quietness is required comprises:
determining whether a location of the terminal device is currently in the scene where quietness is required by positioning a coordinate of the location of the terminal device through GPS and matching a current location in an electronic map database based on the coordinate of the location; and/or
determining whether a current IP address is the scene where quietness is required by matching the IP address with a pre-stored IP address in a quiet-scene database.

8. A non-transitory computer-readable storage medium storing executable instructions that, when executed by an electronic device with a touch-sensitive display, cause the electronic device to:
acquire a first playing position at switching time, during a playing process of the audio-video file, if a switch to a mute mode is detected;
prompt whether to resume playing from the first playing position, if a switch from the mute mode to a non-mute mode is detected; and
resume playing the audio-video file from the first playing position, if the audio-video file is selected to resume playing from the first playing position.

9. The non-volatile computer storage medium according to claim 8 or the invention of any claim herein, wherein the audio-video file is a video file, and
when the first playing position is acquired, the computer executable instructions are further configured to: acquire a current frame of the first playing position or a video clip near the first playing position, and generate a thumbnail of the current frame or a thumbnail video of the video clip; and
when whether to resume playing from the first position is prompted, the computer executable instructions are further configured to: simultaneously display the thumbnail of the current frame of the first playing position or the thumbnail video of the video clip.

10. The non-volatile computer storage medium according to claim 8 or the invention of any claim herein, wherein the audio-video file is played online, and
when the first playing position at the switching time is acquired, the computer executable instructions are further configured to: acquire audio-video file data within a predetermined period of time from the first playing position; and
call firstly the audio-video file data and play the audio-video file data if the audio-video file is selected to resume playing from the first playing position, and download subsequent audio-video file data during the playing.

11. The non-volatile computer storage medium according to claim 8 or the invention of any claim herein, wherein the step to acquire the first playing position at the switching time comprises: acquiring each playing position at switching time of switching to the mute mode; and
if the switch from the mute mode to the non-mute mode is detected, the computer executable instructions are further configured to: display a list of each playing position at the switching time of switching to the mute mode acquired, and prompt to select the position for resuming playing.

12. The non-volatile computer storage medium according to claim 8 or the invention of any claim herein, wherein the computer executable instructions are further configured to:
detect a state of sound playing of a terminal device and a scene in which the terminal device is located, when an instruction for playing the audio-video file is received from a user; and
switch to the mute mode to play the audio-video file according to a received instruction for switching to the mute mode, if the terminal device is in a loudspeaker turn-on mode and in a scene where quietness is required.

13. The non-volatile computer storage medium according to claim 12 or the invention of any claim herein, wherein the detecting the state of the sound playing and the scene in which the terminal device is located comprises:
detecting the state of the sound playing of the terminal device and determining whether the terminal device is in the loudspeaker turn-on mode; and
detecting location information of the terminal device and determining whether the terminal device is in the scene where quietness is required, if the terminal device is in the loudspeaker turn-on mode.

14. The non-volatile computer storage medium according to claim 13 or the invention of any claim herein, wherein the determining whether the terminal device is in the scene where quietness is required comprises:
determining whether a location of the terminal device is currently in the scene where quietness is required by positioning a coordinate of the location of the terminal device through GPS and matching a current location in an electronic map database based on the coordinate of the location; and/or
determining whether a current IP address is the scene where quietness is required by matching the IP address with a pre-stored IP address in a quiet-scene database.

15. An electronic device, comprising:
at least one processor; and
a memory communicably connected with the at least one processor for storing instructions executable by the at least one processor, wherein execution of the instructions by the at least one processor causes the at least one processor to:
acquire a first playing position at switching time, during a playing process of the audio-video file, if a switch to a mute mode is detected;
prompt whether to resume playing from the first playing position, if a switch from the mute mode to a non-mute mode is detected; and
resume playing the audio-video file from the first playing position, if the audio-video file is selected to resume playing from the first playing position.

16. The electronic device according to claim 15 or the invention of any claim herein, wherein the audio-video file is a video file, and
when the first playing position is acquired, the at least one processor is further caused to: acquire a current frame of the first playing position or a video clip near the first playing position, and generate a thumbnail of the current frame or a thumbnail video of the video clip; and
when whether to resume playing from the first position is prompted, the at least one processor is further caused to: simultaneously display the thumbnail of the current frame of the first playing position or the thumbnail video of the video clip.

17. The electronic device according to claim 15 or the invention of any claim herein, wherein the audio-video file is played online, and
when the first playing position at the switching time is acquired, the at least one processor is further caused to: acquire audio-video file data within a predetermined period of time from the first playing position; and
call firstly the audio-video file data and play the audio-video file data if the audio-video file is selected to resume playing from the first playing position, and download subsequent audio-video file data during the playing.

18. The electronic device according to claim 15 or the invention of any claim herein, wherein the acquiring the first playing position at the switching time comprises: acquiring each playing position at switching time of switching to the mute mode; and
if the switch from the mute mode to the non-mute mode is detected, the at least one processor is further caused to: display a list of each playing position at the switching time of switching to the mute mode acquired, and prompt to select the position for resuming playing.

19. The electronic device according to claim 15 or the invention of any claim herein, wherein the at least one processor is further caused to:
detect a state of sound playing of a terminal device and a scene in which the terminal device is located, when an instruction for playing the audio-video file is received from a user; and
switch to the mute mode to play the audio-video file according to a received instruction for switching to the mute mode, if the terminal device is in a loudspeaker turn-on mode and in a scene where quietness is required.

20. The electronic device according to claim 19 or the invention of any claim herein, wherein the detecting the state of the sound playing and the scene in which the terminal device is located comprises:
detecting the state of the sound playing of the terminal device and determining whether the terminal device is in the loudspeaker turn-on mode; and
detecting location information of the terminal device and determining whether the terminal device is in the scene where quietness is required, if the terminal device is in the loudspeaker turn-on mode.
